(19) United States
(12) Patent Application Publication
(10) Pub. No.: US 2023/0345584 A1
(43) Pub. Date: Oct. 26, 2023

(54) HEATER WITH MAGNETIC ATTACHMENT

(71) Applicant: STEVEN C. DIXON, KEYSER, WV (US)

(72) Inventor: STEVEN C. DIXON, KEYSER, WV (US)

(21) Appl. No.: 18/138,031

(22) Filed: Apr. 21, 2023

Related U.S. Application Data
(60) Provisional application No. 63/333,574, filed on Apr. 22, 2022.

(51) Int. Cl. H05B 1/02; F16B 1/00; H05B 3/20

(52) U.S. Cl. CPC H05B 1/0202; F16B 1/00; H05B 3/20; F16B 2001/0035

(57) ABSTRACT

The heater with magnetic attachment is an electric heater adapted for magnetic mounting on ferromagnetic surfaces, such as those commonly found in steel chutes, bins, hoppers and the like. The heater with magnetic attachment includes a thermally conductive plate with a heating element secured thereto, and a cover for the thermally conductive plate. The thermally conductive plate is provided with a plurality of magnets for attachment to a ferromagnetic surface, and the cover is provided with a peripheral seal. The relative spacing between the thermally conductive plate and the cover may be adjusted by the user to tighten the peripheral seal, thus preventing external fluid flow between the thermally conductive plate and the ferromagnetic surface. A light source is provided to indicate when the thermally conductive plate has reached a desired temperature. A thermostat is set to automatically actuate the heating element when the temperature drops below a pre-set level.

### CROSS-REFERENCE TO RELATED APPLICATION

This application claims the benefit of U.S. Provisional Patent Application No. 63,333,574, filed on Apr. 22, 2022.

### BACKGROUND

### 1. Field

The disclosure of the present patent application relates to electric heaters, and particularly to a heater with magnetic attachment for mounting on ferromagnetic surfaces.

### 2. Description of the Related Art

Steel chutes, bins, hoppers and the like that are used for the transfer and storage of bulk materials often require heating. Common bulk materials, such as sand, gravel, coal, ore, sawdust, biomass and the like, often have a moisture content that causes them to freeze relatively fast when in contact with steel in sub-freezing environments. In order to avoid freezing, heaters are commonly applied for heating the steel surface. Such heaters are also commonly employed for heating liquid storage tanks, such as those used for hydraulic oils that are susceptible to low temperature viscosity issues, as well as diesel fuel which has a tendency to congeal at low temperatures.

Propane or diesel fired torpedo type heaters are commonly used for the above applications. Although cost effective, such heaters typically produce several hundred times more heat than is required. Due to this inefficiency in heat, generation, as well as susceptibility to damage from wind, adverse weather conditions and dust, these heaters require frequent maintenance and replacement.

Large electric radiant heaters are also used in these environments, typically being placed a few inches from the steel surface. Due to this spacing, their efficiencies can be greatly lowered by wind blowing between the heater and the surface, as well as accumulations of dust and debris within the, gap. Additionally, heaters of this type operate at very high temperatures, thus risking burns to users or accidental ignition of the bulk materials. Further, due to their size and energy output, these heaters consume very large amounts of electrical power.

Blanket type heaters made from silicone rubber may also be used. Such heaters are glued to the steel surface. Due to this adhesive attachment, the surface must be perfectly clean before application, including being free from frost or ice, and the user must also wait until the adhesive is fully cured before the heater can be used. Panel heaters have also been used, which use an exposed resistance coil-type heating element, thus making them unsuitable for exposure to water. Such heaters also require welding for attachment to the steel surface. Thus, a heater with magnetic attachment solving the aforementioned problems is desired.

### SUMMARY

The heater with magnetic attachment is an electric heater adapted for magnetic mounting on ferromagnetic surfaces, such as those commonly found in steel chutes, bins, hoppers and the like. The heater with magnetic attachment includes a cover having a closed end, an opposed open end, and at least one sidewall, with the closed end having a plurality of openings formed therethrough. A thermally conductive plate has a heating element secured thereto. As a non-limiting example, a heat trace cable (sometimes also referred to as “heating cables” in the art) may be embedded within a mating groove of the thermally conductive plate and held therein with thermally conductive tape, such as aluminum tape or the like. The usage of a heat trace cable as the heating element provides the advantage of not being affected by moisture, even to the degree that a heat trace cable is safe for usage in a fully submerged environment.

As another non-limiting example, a silicone heater pad may be secured to the thermally conductive plate. The heating element is adapted for connection to an electrical power supply for heating the thermally conductive plate, and the thermally conductive plate has a plurality of passages formed therethrough. As a non-limiting example, the thermally conductive plate may be formed from aluminum. A layer of thermally insulating material, such as mineral wool, fiberglass or the like, may be positioned between the thermally conductive plate and the cover.

Regardless of the type of heating element selected, the surface of the thermally conductive plate facing the ferromagnetic surface to be heated may be painted black or otherwise coated or colored with a black material. It has been found that using a black surface raises the temperature of the ferromagnetic surface being heated by 30° F. or more when compared to a similar thermally conductive plate which does not include the black coloration.

A plurality of screws are provided, each having a head and a shaft, where a first portion of the shaft of each of the screws passes through a corresponding one of the passages formed through the thermally conductive plate, and a second portion of the shaft of each of the screws passes through a corresponding one of the openings formed through the closed end of the cover. The first portion of the shaft is positioned adjacent the head of the respective one of the plurality of screws. A plurality of magnets are further provided, each having a central channel formed therethrough. The central channel is contoured to receive and secure a head of a corresponding one of the screws.

A plurality of pairs of retaining nuts are provided such that each of the pairs of retaining nuts threadably engages the first portion of the shaft of a corresponding one of the plurality of screws with the thermally conductive plate being sandwiched between each of the pairs of retaining nuts. A plurality of springs are respectively mounted on the shafts of the plurality of screws such that the plurality of springs are each positioned, between the thermally conductive plate and the cover. The plurality of springs elastically bias the thermally conductive plate with respect to the cover.

A plurality of tension adjusting nuts each threadably engage the second portion of the shaft of a respective one of the plurality of screws. The plurality of tension adjusting nuts are positioned external to the cover, such that the user may selectively tighten and loosen the plurality of tension adjusting nuts to adjust the position of the thermally conductive plate with respect to the cover.

The cover has a peripheral flange projecting outwardly from a free edge adjacent the open end, and a peripheral seal is secured to the peripheral flange. As a non-limiting example, the peripheral seal may be a rubber gasket, a rubber bulb-type compression seal or the like. When the plurality of magnets are secured to a ferromagnetic surface, the plurality of tension adjusting nuts may be tightened to compress and tighten the seal against the ferromagnetic surface. A plurality of lock nuts may be further provided for threadably engaging the second portions of the shafts of respective ones of the plurality of screws to maintain respective ones of the plurality of tension adjusting nuts at desired positions.

Additionally, a light source may be provided to indicate when a desired temperature has been reached. The light source is in communication with a first temperature switch, such as a thermostat or the like, and the electrical power supply. The first temperature switch closes to activate the light source when the thermally conductive plate is at or above the desired temperature. The first temperature switch opens when the thermally conductive plate is below the desired temperature. A second temperature switch, such as a thermostat or the like, is in communication with the heating element and the electrical power supply. The second temperature switch closes to activate the heating element when the thermally conductive plate is below the desired temperature. The second temperature switch opens when the thermally conductive plate is at or above the desired temperature.

It should be understood that the first and second temperature switches do not have to be set at the same desired temperature. As a non-limiting example, the second temperature switch, which may be a hi-metal snap-type thermostat, for example, may be normally closed and can be set to open at a predetermined temperature which is selected to act as a high limit to protect the heating element from exceeding its temperature limit. As another non-limiting example, the temperature limit of the second temperature switch may be set to prevent a possible source of ignition when combustible materials are flowing in a vessel being heated. As a further non-limiting example, the first temperature switch, which may be a bimetal snap-type thermostat, for example, may be normally open and close at a different predetermined temperature in order to illuminate the light source.

Additionally, a release lever may be pivotally secured to the at least one sidewall of the cover. The release lever has a handle portion and an opposed engaging portion. When the handle portion is in a lifted position, the engaging portion extends through a slot formed through the peripheral flange. When the magnets are secured to the ferromagnetic surface, the engaging portion pushes against the support surface to assist in releasing the magnets from the ferromagnetic surface. When the handle portion is lowered, the engaging portion lifts back through the slot, allowing the magnets to securely engage the ferromagnetic surface.

In an alternative embodiment, the heating element is embedded in an upper surface of the thermally conductive plate and may be held therein by high temperature aluminum tape or the like. A plurality of retaining plates are each secured to the upper surface of the thermally conductive plate and extend outwardly therefrom. Each of the retaining plates has a passage formed therethrough. The first portion of the shaft of each of the screws passes through the passage formed through a corresponding one of the retaining plates. In this embodiment, the plurality of springs are respectively positioned between the plurality of retaining plates and the cover, such that the plurality of springs elastically bias, the plurality of retaining plates and the thermally conductive plate with respect to the cover.

A layer of thermally insulating material may be positioned between the thermally conductive plate and the cover. A spacer may be mounted on the upper surface of the thermally conductive plate, such that the spacer defines an air gap between the heating element and the layer of thermally insulating material. A plurality of supports may be respectively secured to the plurality of retaining plates, such that each of the retaining plates is secured to, and extends between, a corresponding one of the supports and the upper surface of the thermally conductive plate. In this embodiment, when the magnets are secured to the ferromagnetic surface, the thermally conductive plate and the supports also make direct contact with the ferromagnetic surface, with the adjustable biasing of the springs ensuring proper alignment and positioning of the thermally conductive plate against the ferromagnetic surface, and further maintaining the direct contact therebetween. Since the thermally conductive plate is exposed in this embodiment, the thermally conductive plate may be encapsulated within, or otherwise coated with, a water-resistant or waterproof material which is also sufficiently thermally conductive.

In another alternative embodiment, a thermally conductive base plate is provided, where the thermally conductive base plate has a plurality of passages formed therethrough for receiving the shafts of the screws. In this embodiment, the thermally conductive base plate is held in place between the pair of retaining nuts and the thermally conductive plate is mounted on an upper surface of the thermally conductive base plate. Similar to the previous embodiment, the heating element is embedded in a recess or groove formed in the upper surface of the thermally conductive plate. The thermally conductive plate and the heating element are may be completely covered and sealed by a sealing cover, which may be formed from any suitable type of thermally conductive material with an IP68 rating for dustproofing and waterproofing. To ensure proper watertight sealing, a seal may be welded, caulked or otherwise formed around the bottom edge of the sealing cover to form a watertight seal against the upper surface of thermally conductive base plate.

These and other features of the present subject matter will become readily apparent upon further review of the following specification and drawings.

### BRIEF DESCRIPTION OF THE DRAWINGS

FIG. 1 is a perspective view of a heater with magnetic attachment.

FIG. 2 is a partial side view in section of the heater with magnetic attachment.

FIG. 3 is a schematic diagram of the electrical system of the heater with magnetic attachment.

FIG. 4 is a partial side view of an alternative embodiment of the heater with magnetic attachment.

FIG. 5 is a partial side view in section of an alternative embodiment of the heater with magnetic attachment.

FIG. 6 is a partial side view in section of another alternative embodiment of the heater with magnetic attachment.

Similar reference characters denote corresponding features consistently throughout the attached drawings.

### DETAILED DESCRIPTION OF THE PREFERRED EMBODIMENTS

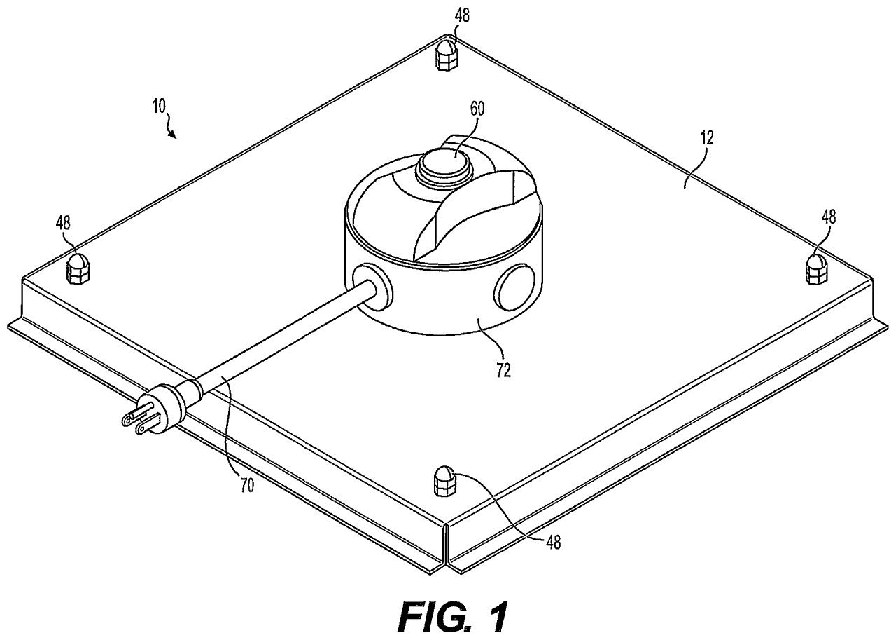

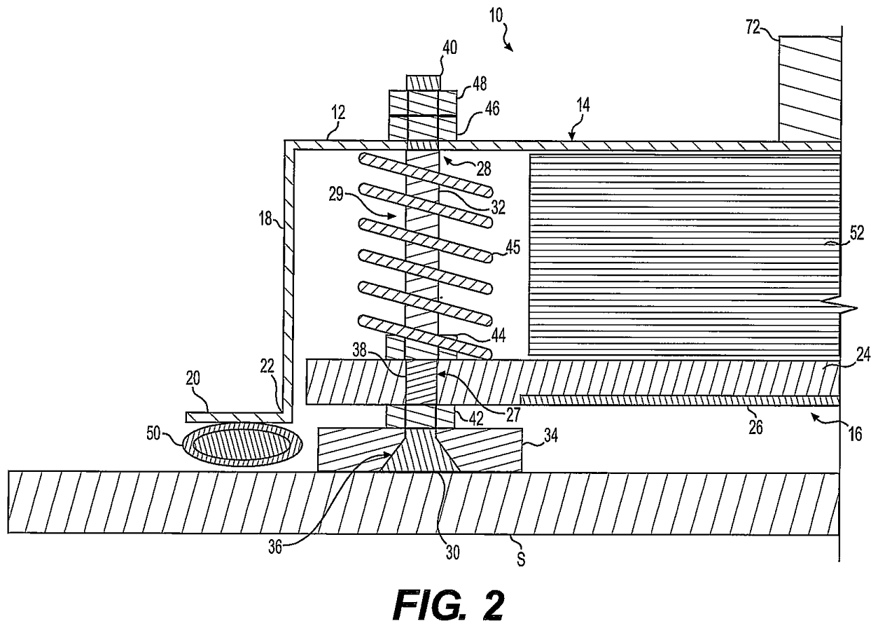

The heater with magnetic attachment 10 is an electric heater adapted for magnetic mounting on ferromagnetic surfaces, such as those commonly found in steel chutes, bins, hoppers and the like. As shown in FIGS. 1 and 2, the heater with magnetic attachment 10 includes a cover 12 having a closed end 14, an opposed open end 16, and at least one sidewall 18, with the closed end 14 having a plurality of openings 28 formed therethrough. It should be understood that the overall shape and relative dimensions of cover 12 are shown in FIGS. 1 and 2 for exemplary purposes only.

A thermally conductive plate 24 has a heating element 26 secured thereto. As a non-limiting example, a heat trace cable (sometimes, also referred to as “heating cables” in the art) may be embedded within a mating groove of the thermally conductive plate 24 and held therein with thermally conductive tape, such as aluminum tape or the like. The heating element 26 is adapted for connection to an electrical power supply for heating the thermally conductive plate 24, and the thermally conductive plate 24 has a plurality of passages 27 formed therethrough. As a non-limiting example, the thermally conductive plate 24 may be formed from aluminum. A layer of thermally insulating material 52, such as mineral wool, fiberglass or the like, may be positioned between the thermally conductive plate 24 and the cover 12. It should be understood that the relative thicknesses of thermally conductive plate 24 and heating element 26 are shown in FIG. 2 for exemplary purposes only. Further, it should be understood that the power cord 70 shown in FIG. 1, which supplies electrical power to the heating element 26, is shown for exemplary purposes only, and may be any suitable type of power cord, power cable or the like, and may also be positioned at any desired location relative to cover 12. Further, it should be understood that power cord 70 may be replaced by an internal power supply, such as rechargeable batteries or the like.

As a non-limiting example, thermally conductive plate 24 may be an aluminum plate with a heat trace cable having 18 to 20 W of heating capacity per foot embedded in a machined groove, with the heat trace cable covered with high temperature, adhesive-backed aluminum tape. This tape restrains the cable from coming out of the groove as it will tend to distort when hot. Heat generated by the heat trace cable is then transferred through the thermally conductive plate 24 to the ferromagnetic surface S to which the heater with magnetic attachment 10 is applied. The usage of a heat trace cable as the heating element 26 provides the advantage of not being affected by moisture, even to the degree that a heat trace cable is safe for usage in a fully submerged environment.

As another non-limiting example, a silicone heater pad may be secured to the thermally conductive plate 24. Such a silicone heater pad may be glued or secured by silicone adhesive to the thermally conductive plate 24, allowing the pad to transfer and dissipate heat over the entire thermally conductive plate 24.

Regardless of the type of heating element 26 selected, the surface of the thermally conductive plate 24 facing the ferromagnetic surface S to be heated may be painted black or otherwise coated or colored with a black material. It has been found that using a black surface raises the temperature of the ferromagnetic surface S being heated by 30° F. or more when compared to a similar thermally conductive plate 24 which does not include the black coloration.

A plurality of screws 29 are provided, each having a head 30 and a shaft 32. A first portion 38 of the shaft 32 of each of the screws 29 passes through a corresponding one of the passages 27 formed through the thermally conductive plate 24, and a second portion 28 of the shaft 32 of each of the screws 29 passes through a corresponding one of the openings 28 formed through the closed end 14 of the cover 12. The first portion 38 of the shaft 32 is positioned adjacent the head 30 of the respective one of the plurality of screws 29. A plurality of magnets 34 axe further provided, each having a central channel 36 formed therethrough. The central channel 36 is contoured to receive and secure the head 30 of a corresponding one of the screws 29. In the non-limiting example of FIGS. 1 and 2, cover 12 and thermally conductive plate 24 have substantially square contours. Thus, four screws 29 and four corresponding passages 27 and channels 28 may be located at the respective four corners. However, it should understood that any suitable number of screws 29 and corresponding passages 27 and channels 28 may be used, and that each may be provided at any desired location with respect to cover 12 and thermally conductive plate 24.

A plurality of pairs of retaining nuts 42, 44 are provided such that each of the pairs of retaining nuts 42, 44 threadably engages the first portion 38 of the shaft 32 of a corresponding one of the plurality of screws 29, with the thermally conductive plate 24 being sandwiched between each of the pairs of retaining nuts 42, 44. A plurality of springs 45 are respectively mounted on the shafts 32 of the plurality of screws 29 such that the plurality of springs 45 are each positioned between the thermally conductive plate 24 and the cover 12. The plurality of springs 45 elastically bias the thermally conductive plate 24 with respect to the cover 12.

A plurality of tension adjusting nuts 46 each threadably engage the second portion 40 of the shaft 32 of a respective one of the plurality of screws 29. The plurality of tension adjusting nuts 46 are positioned external to the cover 12, such that the user may selectively tighten and loosen the plurality of tension adjusting nuts 46 to adjust the position of the thermally conductive plate 24 with respect to the cover 12.

The cover 12 has a peripheral flange 20 projecting outwardly from a free edge 22 adjacent the open end 16, and a peripheral seal 50 is secured to the peripheral flange 20. As a non-limiting example, the peripheral seal 50 may be a rubber gasket, a rubber bulb-type compression seal or the like. When the plurality of magnets 34 are secured to a ferromagnetic surface S, the plurality of tension adjusting nuts 46 may be tightened to compress and tighten the seal 50 against the ferromagnetic surface S. A plurality of lock nuts 48 may be further provided for threadably engaging the second portions 40 of the shafts 32 of respective ones of the plurality of screws 29 to maintain respective ones of the plurality of tension adjusting nuts 46 at desired positions.

The plurality of springs 45 serve to prevent over-compression of the peripheral seal 50 and allow the user to observe the peripheral seal 50 being compressed. Springs 45 further absorb vibration, such as the vibration generated by material flowing through a metal chute. Without springs 45, the weight of the cover 12, when installed either vertically or horizontally, would have an uneven effect on the pressure exerted on the peripheral seal 50, which would be magnified by the inherent vibration.

Additionally, a light source 60 may be provided to indicate when a desired temperature has been reached. In. FIG. 1, light source 60 is shown mounted in casing 72, which is secured centrally on cover 12. It should be understood that the overall contouring, relative dimensions and positioning of casing 72 are shown for exemplary purposes only. Additionally, it should be understood that light source 60 may be any suitable type of electrically powered light source, such as a light bulb, light emitting diode (LED) or the like.

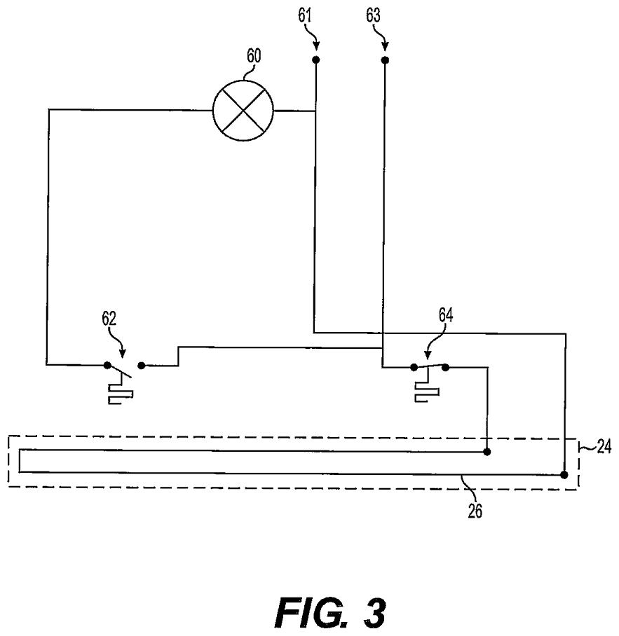

As shown in FIG. 3, the light source 60 is in communication with a first temperature switch 62, such as a thermostat or the like, and the electrical power supply via lines 61 and 63. The first temperature switch 62 closes to activate the light source 60 when the thermally conductive plate 24 is at or above the desired temperature. The first temperature switch 62 opens when the thermally conductive plate 24 is below the desired temperature. A second temperature switch 64, such as a thermostat or the like, is in communication with the heating element 26 and the electrical power supply via lines 61 and 63. The second temperature switch 64 closes to activate the heating element 26 when the thermally conductive plate 24 is below the desired temperature. The second temperature switch 64 opens when the thermally conductive plate 24 is at or above the desired temperature

It should be understood that the first and second temperature switches 62, 64 do not necessarily have to be set at the same desired temperature. As a non-limiting example, the second temperature switch 64, which may be a bi-metal snap-type thermostat, for example, may be normally closed and can be set to open at a predetermined temperature which is selected to act as a high limit to protect the heating element 26 from exceeding its temperature limit. As a non-limiting example, a conventional heat trace cable may have a maximum temperature of about 440° F., and the second temperature switch 64 may be set not to exceed this value. As another non-limiting example, the temperature limit of second temperature switch 64 may be set to prevent a possible source of ignition when combustible materials are flowing in a vessel being heated. As a further non-limiting example, the first temperature switch 62, which may be a bi-metal snap-type thermostat, for example, may be normally open, but closes at a different predetermined temperature, such as 100° F., for example, in order to illuminate the light source 60.

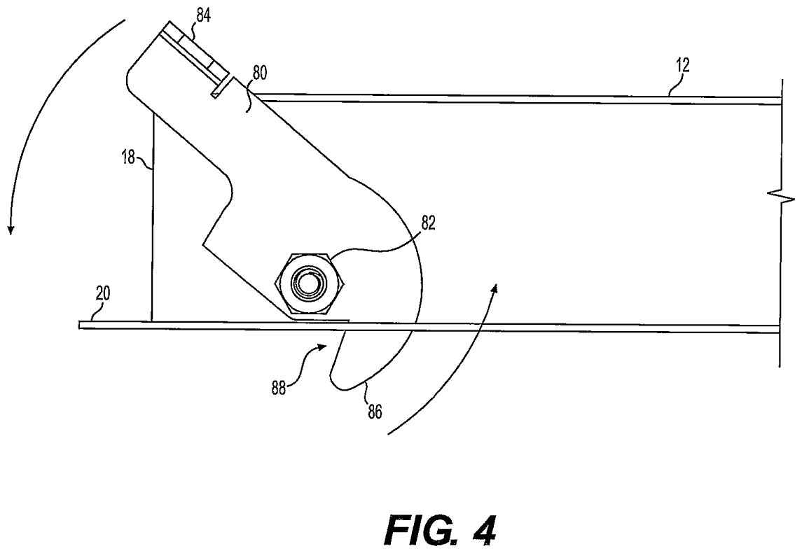

Additionally, as shown in FIG. 4, a release lever 80 may be secured to the at least one sidewall 18. The release lever 80 is pivotally attached to the at least one sidewall 18 by a screw 82, pivot pin or the like, and includes a handle portion 84 and an opposed engaging portion 86. When handle portion 84 is in the raised position shown in FIG. 4, the engaging portion 86 extends through a slot 88 formed through the peripheral flange 20. When magnets 34 are secured to the ferromagnetic surface 5, the engaging portion 86 pushes against the ferromagnetic surface S to assist in releasing the magnets 34 from ferromagnetic surface S. When handle portion 84 is lowered (as indicated by the curved arrow in FIG. 4), the engaging portion 86 lifts back through slot 88, allowing magnets 34 to securely engage the ferromagnetic surface S.

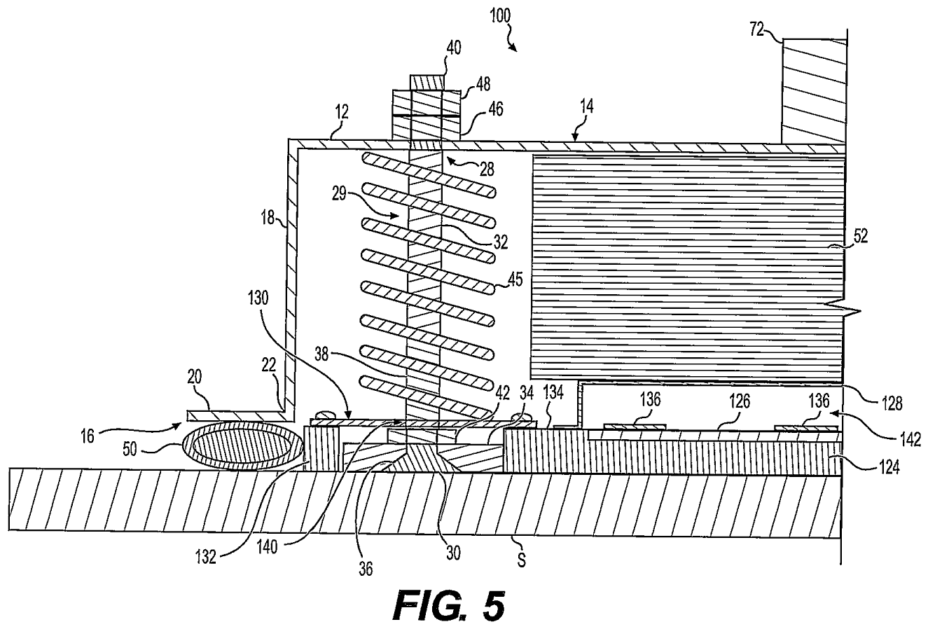

In the alternative embodiment of FIG. 5, the heater with magnetic attachment 100 is substantially similar in construction and operation to the heater with magnetic attachment 10 of FIGS. 1-4, however, the heating element 126 is embedded in a recess or groove formed in the upper surface 134 of the thermally conductive plate 124. The heating element 126 may be held in place by pieces or strips of high temperature aluminum tape 136 or the like. A plurality of retaining plates 130 are each secured to the upper surface 134 of the thermally conductive plate 124 and extend outwardly therefrom. Each of the retaining plates 130 has a passage 140 formed therethrough. The first portion 38 of the shaft 32 of each of the screws 29 passes through the passage 140 formed through a corresponding one of the retaining plates 130. In the embodiment of FIG. 5, the plurality of springs 45 are respectively positioned between the plurality of retaining plates 130 and the cover 12, such that the plurality of springs 45 elastically bias the plurality of retaining plates 130 and the thermally conductive plate 124 with respect to the cover 12.

Similar to the previous embodiment, a layer of thermally insulating material 52 may be positioned between the thermally conductive plate 124 and the cover 12. However, a spacer 128 may be mounted on the upper surface 134 of the thermally conductive plate 124, such that the spacer 128 defines and maintains an air gap 142 between the heating element 126 and the layer of thermally insulating material 52. A plurality of supports 132 may be respectively secured to the plurality of retaining plates 130, such that each of the retaining plates 130 is secured to, and extends between, a corresponding one of the supports 132 and the upper surface 134 of the thermally conductive plate 124. It should be understood that retaining plates 130 may be secured to the supports 132 and the thermally conductive plate 124 using any suitable type of attachment, such as bolts, rivets, screws or the like.

In the embodiment of FIG. 5, when the magnets 34 are secured to the ferromagnetic surface S, the thermally conductive plate 124 and the supports 132 also make direct contact with the ferromagnetic surface S, with the adjustable biasing of the springs 45 ensuring proper alignment and positioning of the thermally conductive plate 124 against the ferromagnetic surface S, and further maintaining the direct contact therebetween.

Each of the supports 132 preferably has a height equal to the thickness of the thermally conductive plate 124, such that each retaining plate 130 is substantially parallel to the ferromagnetic surface S when applied. This allows the maintains proper alignment of the screws 29 and allows the corresponding magnets 34 and the contact surface of the thermally conductive plate 124 to be pressed flush against the ferromagnetic surface S and maintain proper alignment therewith, particularly under the elastic force supplied by springs 45. Additionally, since the thermally conductive plate 124 is exposed in this embodiment, the thermally conductive plate 124 may be encapsulated within, or otherwise coated with, a water-resistant or waterproof material which is also sufficiently thermally conductive. As a non-limiting example, a thermally conductive material with an IP68 rating for dustproofing and waterproofing may be used. As in the previous embodiment, regardless of any additional coating material, the surface of the thermally conductive plate 124 and/or any additional coating which faces the ferromagnetic surface S is preferably painted black or otherwise coated or colored with a black material. Further, it should be understood that the heater with magnetic attachment 100 of FIG. 5 may also include a light source, temperature switches and a release lever similar to those described above with regard to the heater with magnetic attachment 10 of the previous embodiment.

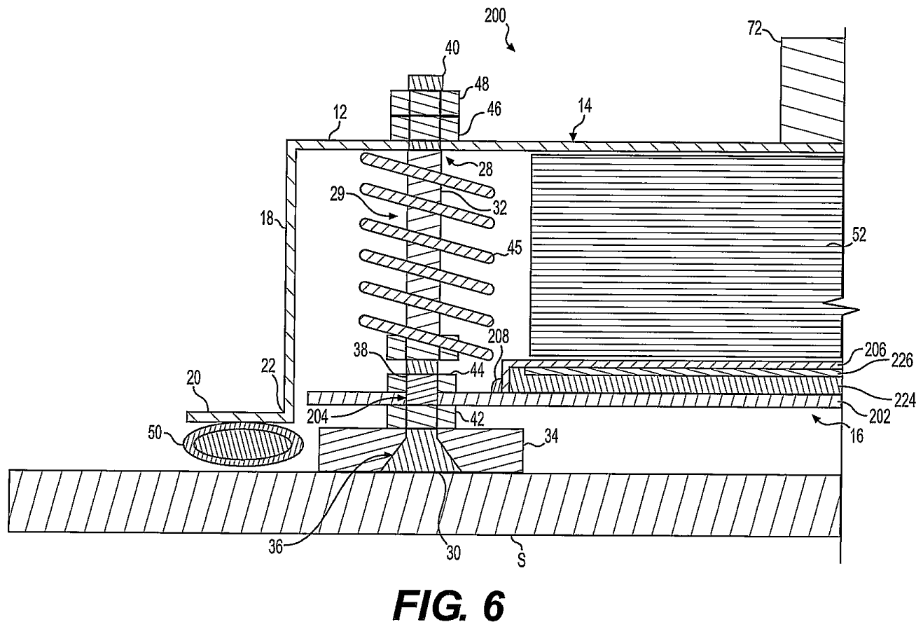

In the further alternative embodiment of FIG. 6, the heater with magnetic attachment 200 is similar to the heater with magnetic attachment 10 of FIG. 2, however, a thermally conductive base plate 202 has been added and the thermally conductive plate 224 has been shortened, such that shaft 32 of screw 29 passes through a passage 204 formed through the thermally conductive base plate 202, with thermally conductive base plate 202 being held in place between the pair of retaining nuts 42, 44. The thermally conductive plate 224 is mounted on an upper surface of the thermally conductive base plate 202. Additionally, the heating element 226 is embedded in a recess or groove formed in the upper surface of the thermally conductive plate 224, similar to the embodiment of FIG. 5. As shown, the thermally conductive plate 224 and the heating element 226 are completely covered and sealed by sealing cover 206, which may be formed from any suitable type of thermally conductive material with an IP68 rating for dustproofing and waterproofing. To ensure proper watertight sealing, seal 208 may be welded, caulked or otherwise formed around the bottom edge of sealing cover 206 to form a watertight seal against the upper surface of thermally conductive base plate 202.

It is to be understood that the heater with magnetic attachment is not limited to the specific embodiments described above, but encompasses any and all embodiments within the scope of the generic language of the, following claims enabled by the embodiments described herein, or otherwise shown in the drawings or described above in terms sufficient to enable one of ordinary skill in the art to make and use the claimed subject matter.

I claim:

1. A heater with magnetic attachment, comprising:
a cover having a closed end, an opposed open end, and, at least one sidewall, the closed end having a plurality of openings formed therethrough;
a thermally conductive plate having a heating element secured thereto, the thermally conductive plate having a plurality of passages formed therethrough, the heating element being adapted for connection to an electrical power supply for heating the thermally conductive plate;
a plurality of screws, each of the screws having a head and a shaft, a first portion of the shaft of each of the screws passing through a corresponding, one of the passages formed through the thermally conductive plate, and a second portion of the shaft of each of the screws passing through a corresponding one of the openings formed through the closed end of the cover, the first portion of the shaft being positioned adjacent the head of the respective one of the plurality of screws;
a plurality of magnets, each of the magnets having a central channel formed therethrough, the central channel being configured to receive and secure a head of a corresponding one of the screws;
a plurality of pairs of retaining nuts, each of the pairs of retaining nuts threadably engaging the first portion of the shaft of a corresponding one of the plurality of screws with the thermally conductive plate being sandwiched between each of the pairs of retaining nuts;
a plurality of springs respectively mounted on the shafts of the plurality of screws, the plurality of springs each, being positioned between the thermally conductive plate and the cover and resiliently biasing the thermally conductive plate with respect to the cover; and
a plurality of tension adjusting nuts, each of the tension adjusting nuts threadably engaging the second portion of the shaft of a respective one of the plurality of screws, the plurality of tension adjusting nuts being positioned external to the cover, so that selective tightening and loosening of the plurality of tension adjusting nuts adjusts a position of the thermally conductive plate with respect to the cover.

2. The heater with magnetic attachment as recited in claim 1, wherein the cover has a peripheral flange projecting outwardly from a free edge adjacent the open end.

3. The heater with magnetic attachment as recited in claim 2, further comprising a peripheral seal secured to the peripheral flange.

4. The heater with magnetic attachment as recited in claim 2, further comprising a release lever pivotally secured to the at least one sidewall of the cover, the release lever having a handle portion and an opposed engaging portion, the engaging portion selectively passing through a slot formed through the peripheral flange.

5. The heater with magnetic attachment as recited in claim 1, further comprising:
a light source; and
a first temperature switch in communication with the light source and the electrical power supply, the first temperature switch closing to activate the light source when the thermally conductive plate is at or above a desired temperature, the first temperature switch opening when the thermally conductive plate is below the desired temperature.

6. The heater with magnetic attachment as recited in claim 5, further comprising a second temperature switch in communication with the heating element and the electrical power supply, the second temperature switch closing to activate the heating element when the thermally conductive plate is below the desired temperature, the second temperature switch opening when the thermally conductive plate is at or above the desired temperature.

7. A heater with magnetic attachment, comprising:
a cover having a closed end, an opposed open end, and at least one sidewall, the closed end having a plurality of openings formed therethrough;
a thermally conductive plate having a heating element secured thereto, the thermally conductive plate having a plurality of passages formed therethrough, the heating element being adapted for connection to an electrical power supply for heating the thermally conductive plate;
a plurality of screws, each of the screws having a head and a shaft, a first portion of the shaft of each of the screws passing through a corresponding one of the passages formed through the thermally conductive plate, and a second portion of the shaft of each of the screws passing through a corresponding one of the openings formed through the closed end of the cover, the first portion of the shaft being positioned adjacent the head of the respective one of the plurality of screws;
a plurality of magnets, each of the magnets having a central channel formed therethrough, the central channel being configured to receive and secure a head of a corresponding one of the screws;
a light source;
a first temperature switch in communication with the light source and the electrical power supply, the first temperature switch closing to activate the light source when the thermally conductive plate is at or above a desired temperature, the first temperature switch opening when the thermally conductive plate is below the desired temperature.

8. The heater with magnetic attachment as recited in claim 7, further comprising:
a plurality of pairs of retaining nuts, wherein each of the pairs of retaining nuts threadably engages the first portion of the shaft of a corresponding one of the plurality of screws with the thermally conductive plate being sandwiched between each of the pairs of retaining nuts;
a plurality of springs respectively mounted on the shafts of the plurality of screws, the plurality of springs each being positioned between the thermally conductive plate and the cover, and resiliently biasing the thermally conductive plate with respect to the cover; and
a plurality of tension adjusting nuts, each of the tension adjusting nuts threadably engaging the second portion of the shaft of a respective one of the plurality of screws, the plurality of tension adjusting nuts being positioned external to the cover, so that selective tightening and loosening of the plurality of tension adjusting nuts adjusts a position of the thermally conductive plate with respect to the cover.

9. The heater with magnetic attachment as recited in claim 7, further comprising a second temperature switch in communication with the heating element and the electrical power supply, the second temperature switch closing to activate the heating element when the thermally conductive plate is below the desired temperature, the second temperature switch opening when the thermally conductive plate is at or above the desired temperature.

10. A heater with magnetic attachment, comprising:
a cover having a closed end, an opposed open end, and at least one sidewall, the closed end having a plurality of openings formed therethrough;
a thermally conductive plate having a heating element embedded in an upper surface thereof, the heating element being adapted for connection to an electrical power supply for heating the thermally conductive plate;
a plurality of retaining plates, each of the retaining plates being secured to the upper surface of the thermally conductive plate and extending outwardly therefrom, each of the retaining plates having a passage formed therethrough;
a plurality of screws, each of the screws having ahead and a shaft, a first portion of the shaft of each of the screws passing through the passage formed through a corresponding one of the retaining plates, and a second portion of the shaft of each of the screws passing through a corresponding one of the openings formed through the closed end of the cover, the first portion of the shaft being positioned adjacent the head of the respective one of the plurality of screws;
a plurality of magnets, each of the magnets having a central channel formed therethrough, the central channel being configured to receive and secure a head of a corresponding one of the screws;
a plurality of springs respectively mounted on the shafts of the plurality of screws, the plurality of springs being respectively positioned between the plurality of retaining plates and the cover, the plurality of springs resiliently biasing the plurality of retaining plates and the thermally conductive plate with respect to the cover; and
a plurality of tension adjusting nuts, each of the tension adjusting nuts threadably engaging the second portion of the shaft of a respective one of the plurality of screws, the plurality of tension adjusting nuts being positioned external to the cover, so that selective tightening and loosening of the plurality of tension adjusting nuts adjusts the resilient biasing of the thermally conductive plate with respect to the cover.

11. The heater with magnetic attachment as recited in claim 10, wherein the cover has a peripheral flange projecting outwardly from a free edge adjacent the open end.

12. The heater with magnetic attachment as recited in claim 11, further comprising a peripheral seal secured to the peripheral flange.

13. The heater with magnetic attachment as recited in claim 11, further comprising a release lever pivotally secured to the at least one sidewall of the cover, the release lever having a handle portion and an opposed engaging portion, the engaging portion selectively passing through, a slot formed through the peripheral flange.

14. The heater with magnetic attachment as recited in claim 10, further comprising:
a light source; and
a first temperature switch in communication with the light source and the electrical power supply, the first temperature switch closing to activate the light source when the thermally conductive plate is at or above a desired temperature, the first temperature switch opening when the thermally conductive plate is below the desired temperature.

15. The heater with magnetic attachment as recited in claim 14, further comprising a second temperature switch in communication with the heating element and the electrical power supply, the second temperature switch closing to activate the heating element when the thermally conductive plate is below the desired temperature, the second temperature switch opening when the thermally conductive plate is at or above the desired temperature.

16. The heater with magnetic attachment as recited in claim 10, further comprising a layer of thermally insulating material positioned between the thermally conductive plate and the cover.

17. The heater with magnetic attachment as recited in claim 16, further comprising a spacer mounted on the upper surface of the thermally conductive plate, the spacer defining an air gap between the heating element and the layer of thermally insulating material.

18. The heater with magnetic attachment as recited in claim 10, further comprising a plurality of supports respectively secured to the plurality of retaining plates, each of the retaining plates being secured to and extending between a corresponding one of the supports and the upper surface of the thermally conductive plate.

19. A heater with magnetic attachment, comprising:
a cover having a closed end, an opposed open end, and at least one sidewall, the closed end having a plurality of openings formed therethrough;
a base plate having a plurality of passages, formed therethrough;
a thermally conductive plate mounted on an upper surface of the base plate and having a heating element embedded in an upper surface thereof, the heating element being adapted for connection to an electrical power supply for heating the thermally conductive plate;
a plurality of screws, each of the screws having a head and a shaft, a first portion of the shaft of each of the screws passing through a corresponding one of the passages formed through the base plate, and a second portion of the shaft of each of the screws passing through a corresponding one of the openings formed through the closed end of the cover, the first portion of the shaft being positioned adjacent the head of the respective one of the plurality of screws;
a plurality of magnets, each of the magnets having a central channel formed therethrough, the central channel being configured to receive and secure a head of a corresponding one of the screws;
a plurality of pairs of retaining nuts, each of the pairs of retaining nuts threadably engaging the first portion of the shaft of a corresponding one of the plurality of screws with the thermally conductive plate being sandwiched between each of the pairs of retaining nuts;
a plurality of springs respectively mounted on the shafts of the plurality of screws, the plurality of springs each being positioned between the thermally conductive plate and the cover and resiliently biasing the thermally conductive plate with respect to the cover; and
a plurality of tension adjusting nuts, each of the tension adjusting nuts threadably engaging the second portion of the shaft of a respective one of the plurality of screws, the plurality of tension adjusting nuts being positioned external to the cover, so that selective tightening and loosening of the plurality of tension adjusting nuts adjusts a position of the thermally conductive plate with respect to the cover.

20. The heater with magnetic attachment as recited in claim 19, further comprising a sealing cover for covering the thermally conductive plate and the heating element, the sealing cover sealing the thermally conductive plate against the base plate.
